(19) United States
(12) Patent Application Publication
(10) Pub. No.: US 2004/0181912 A1
(43) Pub. Date: Sep. 23, 2004

(54) Article comprising an ergonomic handle

(76) Inventor: Ilya Feygin, Mountainside, NJ (US)

Correspondence Address: DEMONT & BREYER, LLC, SUITE 250, 100 COMMONS WAY, HOLMDEL, NJ, 07733, US

(21) Appl. No.: 10/769,438

(22) Filed: Jan. 30, 2004

Related U.S. Application Data
(60) Provisional application No. 60/443,792, filed on Jan. 30, 2003.

(51) Int. Cl. E05B 1/00

(52) U.S. Cl. 16/422

(57) ABSTRACT

The illustrative embodiment of the present invention is a handle that engages a wide variety of elongated-shape tools to provide an ergonomic grip. In accordance with the illustrative embodiment, the ergonomic handle includes a grip, a tightening/locking arrangement, and a coupler. The handle is easily adjustable and reliably positioned to accommodate different gripping styles, different positioning patterns and right- or left-handed use. Additionally, the handle accommodates are variety of hand sizes.

### STATEMENT OF RELATED CASES

This case claims priority of U.S. provisional patent application 60/443,792, which was filed on Jan. 30, 2004, which is incorporated by reference herein.

### FIELD OF THE INVENTION

The present invention relates to an ergonomic handle.

### BACKGROUND

Hand-held instruments are used in many different industrial and consumer applications. Typical applications for such instruments include the laboratory (e.g., pipetters, dissecting tools, spotters, micro-manipulators, etc.), health care (e.g., surgical tools, syringes, etc.), and assembly-line operations in electronics, optical, and other industries (e.g., soldering, testing, etc.), to name but a few.

The long-term use of these instruments requires an ergonomically-correct gripping mechanism to avoid the risk of repetitive stress injuries (e.g., carpel tunnel syndrome, etc.). Ideally, the gripping mechanism will accommodate a wide range of hand sizes, a variety of gripping styles and positioning patterns, as well as ambidextrous use.

### SUMMARY

The illustrative embodiment of the present invention is a handle that engages a wide variety of elongated-shape tools to provide an ergonomic grip. The handle is easily adjustable and reliably positioned to accommodate different gripping styles, different positioning patterns and right- or left-handed use. Additionally, the handle accommodates are variety of hand sizes.

In accordance with the illustrative embodiment, the ergonomic handle includes a grip, a tightening/locking arrangement, and a coupler.

The coupler includes standoff and a receiver. The receiver receives the elongated body of a tool to be used with the ergonomic handle. The tightening/locking arrangement includes a tightener and a lock. The tightener, which is typically a shaft, is received by a bore in the standoff. The tightener serves to tighten the grip to the tool. In some embodiments, the tightener is a screw, and the lock is threads in the bore that receive the screw in threaded engagement.

### BRIEF DESCRIPTION OF THE DRAWINGS

FIG. 1 depicts a cross-sectional view of an ergonomic handle, attached to a tool, in accordance with the illustrative embodiment of the present invention.

FIG. 2 depicts a side view of the ergonomic handle of FIG. 1.

FIG. 3 depicts a variation of the illustrative embodiment wherein a locking insert is used.

### DESCRIPTION

The illustrative embodiment of the present invention is an ergonomic handle that engages a wide variety of elongated-shape tools. The inventive handle is particularly useful for applications in which:

very high positioning accuracy is required; or

slippage should be avoided; or

extra leverage is required.

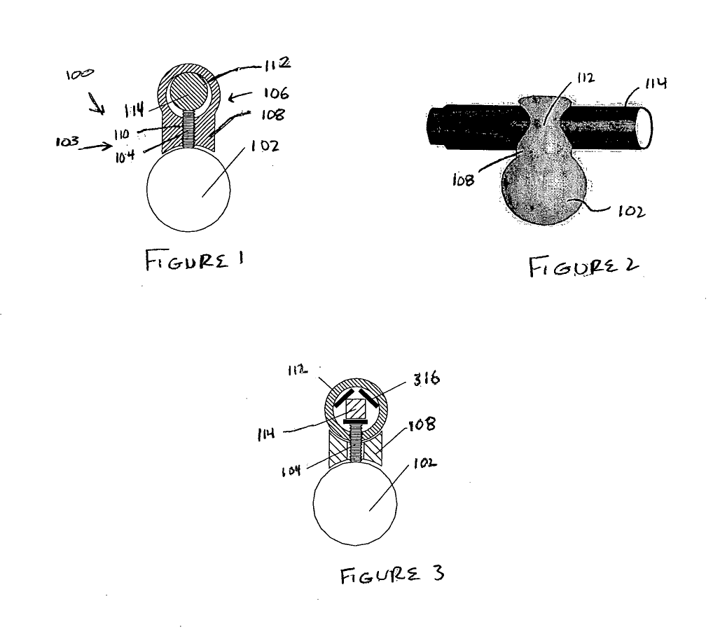

FIG. 1 depicts a cross-section of handle 100 in accordance with the illustrative embodiment of the present invention. FIG. 1 depicts handle 100 engaged to tool 114 having a cylindrical shape. FIG. 2 shows a side view of handle 100 engaged to tool 114.

In the illustrative embodiment depicted in FIGS. 1 and 2, handle 100 includes grip 102, a tightening/locking arrangement 103, and coupler 106, interrelated as shown.

Grip 102 advantageously, but not necessarily, has a spherical shape. Grip can be formed from any of a wide variety of materials (e.g., wood, plastic, foam, rubber, metal, etc.) and can be hard or soft. A first spherical grip having a diameter of 2 centimeters and a second spherical grip having a diameter of 2.5 centimeters were tested. Both size grips were found to be acceptable by many different operators.

In the illustrative embodiment, tightening/locking arrangement includes tightener 104 and a lock. The tightener, which couples to grip 102, tightens the grip to tool 114. In the illustrative embodiment, tightener 104 is realized as a shaft, which is advantageously a screw. The shaft is rigidly fixed to grip 102. As described further below, in some embodiments, the lock is realized as a threaded bore, which receives the screw.

Coupler 106 includes standoff 108 and receiver 112 (the standoff and the receiver portions of coupler 106 are not to scale).

Receiver 112 of coupler 106 receives the elongated body of tool 114. Tightener 104 is received by bore 110 of standoff 108. In the illustrative embodiment, the bore is threaded. The threaded bore, which serves as the “lock” in tightening/locking arrangement 103, receives the screw in threaded engagement, thereby fix tightener 104 in place against tool 114. In some variations, tightener 104 is realized as a shaft but not a screw. In such cases, a different locking arrangement is required to lock tightener 104 in position. In some embodiments, a set screw (not depicted) that enters through the side of standoff 108 is used for this purpose. A variety of other locking arrangements, as will be familiar to those skilled in the art, can suitably be used.

To tighten and lock grip 102 to tool 114, grip 102 is turned to thread (or otherwise drive) tightener 204 toward tool 114. Eventually, tightener 104 abuts tool 114. With continued applied torque (when tightener 104 is a screw), tool 114 is forced against the inside surface of receiver 112 and is locked in that position as a consequence of the threaded engagement between threaded (screw) tightener 104 and threaded bore 110 (or locked by virtue of an independent locking arrangement).

It will be appreciated that the position of grip 102 along tool 114 is readily adjusted (e.g., for use by different operators) by simply loosening tightener 104 (i.e., by turning grip 102), repositioning grip 102 along tool 114, and then re-tightening.

FIG. 3 depicts a variation of the illustrative embodiment wherein locking insert 316 is used. Locking insert is advantageously used when tool 114 does not have a cylindrical shape. In the variation depicted in FIG. 3, locking insert 316 comprises three plates 318. The plates provide additional points of contact against the inside surface of receiver 112 to prevent slippage of tool 114 within receiver 112.

It is to be understood that the above-described embodiments are merely illustrative of the present invention and that many variations of the above-described embodiments can be devised by those skilled in the art without departing from the scope of the invention. For example, in this specification, specific details are provided in order provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Furthermore, the particular features, structures, materials, or characteristics can be combined in any suitable manner in one or more embodiments. It is therefore intended that such variations be included within the scope of the following claims and their equivalents.

I claim:

1. An article comprising:
a grip;
a tightening/locking arrangement, wherein:
said tightening/locking arrangement comprises a shaft; and
said shaft is coupled to said grip; and
a coupler, wherein said coupler has:
a standoff, wherein said standoff has a bore that receives said shaft; and
a receiver, wherein:
said bore communicates with said receiver; and
said receiver receives a tool.

2. The article of claim 1 wherein:
said shaft is threaded;
said bore is threaded to engage said shaft; and
said tightening/locking arrangement further comprises said bore.

3. The article of claim 1 wherein said grip is spherical.

4. The article of claim 1 wherein said receiver has a circular cross section.

5. The article of claim 1 further comprising said tool.

6. The article of claim 5 wherein said tool is cylindrical.

7. The article of claim 1 further comprising a locking insert, wherein said locking insert is disposed within said receiver.

8. The article of claim 7 wherein said locking insert comprises three plates.

9. The article of claim 1 wherein said grip has a size in a range of about 2 to 2.5 centimeters.

10. An article comprising:
a grip;
a shaft, wherein said shaft is coupled to said grip;
a coupler, wherein said coupler has:
a receiver, wherein said receiver receives a tool, and
a standoff, wherein said standoff has a bore that communicates with said receiver and wherein said bore receives said shaft.

11. The article of claim 10 wherein said shaft is threaded.

12. The article of claim 11 wherein said bore is threaded.

13. The article of claim 10 wherein said grip is spherical.

14. The article of claim 10 wherein said receiver has a circular cross section.

15. The article of claim 10 further comprising said tool.

16. The article of claim 10 wherein said tool is cylindrical.

17. The article of claim 10 further comprising a locking insert, wherein said locking insert is disposed within said receiver.

18. The article of claim 17 wherein said locking insert comprises three plates.

19. The article of claim 10 wherein said grip has a size in a range of about 2 to 2.5 centimeters.
